(19) United States
(12) Patent Application Publication
(10) Pub. No.: US 2010/0247046 A1
(43) Pub. Date: Sep. 30, 2010

(54) WIDE BANDWIDTH, LOW LOSS PHOTONIC BANDGAP FIBERS

(75) Inventors: Liang Dong, Ann Arbor, MI (US); Brian K. Thomas, Brighton, MI (US); Shigeru Suzuki, Ann Arbor, MI (US); Libin Fu, Ann Arbor, MI (US)

Correspondence Address: KNOBBE MARTENS OLSON & BEAR LLP, 2040 MAIN STREET, FOURTEENTH FLOOR, IRVINE, CA, 92614, US

(73) Assignee: IMRA AMERICA, INC., Ann Arbor, MI (US)

(21) Appl. No.: 12/750,559

(22) Filed: Mar. 30, 2010

Related U.S. Application Data
(60) Provisional application No. 61/165,328, filed on Mar. 31, 2009.

(51) Int. Cl. G02B 6/02; B29D 11/00

(52) U.S. Cl. 385/123; 264/1.28

(57) ABSTRACT

Various embodiments described herein comprise hollow core (HC) photonic bandgap fibers (PBGF) with a square lattice (SQL). In various embodiments the, HC SQL PBGF includes a cladding region comprising 2-10 layers of air-holes. In various embodiments, the HC SQL PBGF can be configured to provide a relative wavelength transmission window Δλ/λc larger than about 0.35 and minimum transmission loss in a range from about 70 dB/km to about 0.1 dB/km. In some embodiments, the HC SQL PBGF fiber can be a polarization maintaining fiber. Methods of fabricating such fibers are also disclosed herein along with some examples of fabricated fibers. Various applications of such fibers are also described herein.

### CROSS-REFERENCE TO RELATED APPLICATIONS

This application claims the benefit under 35 U.S.C. §119(e) of U.S. Provisional Application No. 61/165,328, titled “WIDE BANDWIDTH, LOW LOSS PHOTONIC BANDGAP FIBERS,” filed on Mar. 31, 2009 which is hereby incorporated by reference herein in its entirety.

This application is also related to U.S. Pat. No. 7,209,619, entitled “Photonic Bandgap Fibers” filed on Dec. 30, 2005 (IMRAA.032A), and U.S. Pat. No. 7,418,836, filed on Mar. 15, 2007, entitled “Photonic Bandgap Fibers” (IMRAA.032DV1), each of which is hereby incorporated by reference herein in its entirety.

### BACKGROUND OF THE INVENTION

1. Field of the Invention

This application relates to optical fibers in general and to photonic bandgap fibers in particular. Some aspects of this application are directed towards a photonic bandgap fiber having increased transmission bandwidth.

2. Description of the Related Art

Hollow core (HC) photonic bandgap fibers (PBGF) can be useful for many applications. Light in hollow core photonic bandgap fibers is substantially confined to a hollow core by a photonic bandgap in the cladding structure. Because light is largely guided in the air in hollow core PBGFs, high nonlinear thresholds can be obtained. Transmission, delivery and shaping of optical pulses with very high peak powers is possible in such fibers. HC PBGFs can also be useful for spectroscopy of gases due to the increase in interaction length when light is in a low loss guided mode.

HC PBGFs with hexagonally arranged cladding structures have been demonstrated and studied in the last decade. HC PBGFs having low loss, for example approximately 1 dB/km, and having a bandgap of approximately 300 nm centered around 1550 nm have been previously reported. In some embodiments, the limited width of the bandgap can be a practical constraint. For example, in some embodiments, the center of the bandgap may need to be carefully controlled to provide the correct transmission characteristic at a pre-determined wavelength. In some embodiments, the bandgap width can also be important for applications that require low third order dispersion, such as pulse shaping, and for applications which require wide bandgaps for new wavelength generation and spectroscopy.

The conventional PBGF cladding structure with a hexagonal lattice has limited bandgap which may make it difficult to increase its transmission window. An improvement in both design and fabrication of a PBGF that may increase the transmission bandwidth while supporting low-loss single mode propagation is desirable.

### SUMMARY OF THE INVENTION

Various embodiments include hollow core (HC) photonic bandgap fibers (PBGFs) with a square lattice (SQL) configured with a wide transmission window and low loss. Various embodiments described herein include fibers that are fabricated with core and cladding pressure control that improves the air filling fraction. In at least some embodiments, a relative transmission window of at least about 35% (Δλ/λc=0.35) is obtained, and up to about 65% can be obtained, when Δλ is measured by the width of the transmission curve at approximately 10% of the maximum intensity. Some embodiments describe a SQL photonic bandgap fiber with relative bandgap beyond 40%.

In various embodiments described herein a HC SQL PBGF may be utilized for delivery of high peak power optical pulses, pulse shaping, or in sensor applications. Some embodiments described herein comprise a method for fabrication of a HC PBGFs. Various embodiments described herein comprise a method for fabricating a polarization maintaining (PM) HC PBGF. Various embodiments of a HC SQL PBGF may comprise 2-10 layers of air-holes. Some embodiments describe a fiber having Δλ/λc=0.45 and a loss as low as approximately 70 dB/km with 5 layers of air holes.

Various embodiments described herein comprise a photonic bandgap fiber (PBGF) for propagating light having a wavelength, λ. In some embodiments, the fiber comprises a core, and a cladding disposed about the core. The cladding may comprise a plurality of regions, at least one region having a dimension, Λ, and configured such that the cladding at least partially surrounds a hole having a hole dimension, D. In some embodiments, the plurality of regions may be arranged as a rectangular lattice. In various embodiments, the portions of the cladding form webs and nodes of the lattice such that at least a portion of the webs have a dimension, d₂, and are configured as higher aspect ratio cladding material portions. A portion of the webs may be connected to the nodes and at least a portion of the nodes may have a dimension, d₁, and be configured as lower aspect ratio cladding material portions. In various embodiments, D/Λ is in a range from about 0.9 to about 0.995 and the PBGF is configured such that a relative wavelength transmission window Δλ/λc is larger than about 0.35.

In various embodiments, the webs have a second dimension d₃, such that the ratio of d₃ to d₂ is at least approximately 5:1. In various embodiments the ratio of d₃ to d₂ is at least approximately 10:1 or at least 25:1.

In various embodiments, d₂/Λ maybe in a range from about 0.01 to about 0.1, and d₁/Λ in a range from about 0.1 to about 0.5. In various embodiments, Δλ/λc may be in the range from about 0.35 to about 0.65. In various embodiments, the rectangular lattice may comprise 2 to 5 layers of cladding material. In various embodiments, the fiber is drawn from a preform having webs and nodes having sizes larger than d₁ and d₂, and the PBGF is configured such that a relative reduction in the node size is substantially less than a relative reduction in the web size. In various embodiments, the preform may be configured with preform parameters D/Λ=0.5-0.95, d₂/Λ=0.05-0.5, and d₁/Λ=0.2-0.6. In various embodiments an air filling fraction may exceed about 80%, and be up to about 95%. In various embodiments a dimension of the core may be in a range from about 10 μm to about 100 μm. In various embodiments, the fiber may be configured as a polarization maintaining SQL PBGF. In various embodiments, the holes may contain air. In various embodiments at least a portion of the high index cladding glass may comprise silica.

Various embodiments comprise a method of fabricating such a SQL PBGF. The method comprises stacking capillaries and rods to form a rectangular lattice. The rods comprise an optical material. The method comprises constructing a preform, and drawing the preform into a fiber. In some embodiments, the method comprises controlling core and cladding pressure during the drawing, with the core and cladding pressurized with different pressures. The controlling of the core and cladding pressures narrows a web dimension, d₂, and substantially limits changes in node dimension, d₁, of the SQL PBGF such that D/Λ is in a range from about 0.9 to about 0.99.

In various embodiments, cladding holes may be pressurized from about 0.5 to about 2.5 psi and the core may be pressurized from about of 0.2 to about 2 psi, and the pressurization of cladding holes exceeds pressurization of the core. In various embodiments a web dimension, d₂, is less than about 0.25 μm.

Various embodiments comprise a method of making a polarization maintaining (PM) PBGF. The method comprises forming a cane comprising a lattice of cladding regions, and a core. The cane has a substantially circular outer diameter, and comprises an optical material. The method comprises forming a circular preform using the cane, modifying the circular preform to form a non-circular shape, and drawing the preform into a fiber. The method comprises transforming four-fold symmetry of the lattice into two-fold symmetry by deforming the core and the cladding during the drawing, thereby introducing birefringence into the fiber. In various embodiments the non-circular shape comprises flat boundary portions disposed opposite each other, and at a non-zero angle relative to axes defining the lattice. In various embodiments the lattice comprises a rectangular lattice.

Various embodiments described herein comprise a system for telecommunications, gas measurement, delivery of high peak power pulses, or laser pulse shaping, comprising a SQL PBGF.

In some embodiments, a SQL PBGF is disclosed. The SQL PBGF comprises a cladding region having 2-10 layers of air-holes and configured to provide a relative wavelength transmission window Δλ/λc larger than about 0.35 and minimum transmission loss in a range from about 70 dB/km to about 0.1 dB/km.

In various embodiments a photonic bandgap fiber (PBGF) for propagating light having a wavelength, λ, is disclosed. The PBGF fiber comprises a core; and a cladding region disposed about said core. The cladding region may comprise a plurality of features, the features having a periodicity, Λ. The cladding region may be configured such that the cladding region at least partially surrounds a hole having a hole dimension, D. In various embodiments, the plurality of features maybe arranged as a rectangular lattice. The cladding region may comprise webs and nodes of the lattice such that the webs have a width, d₂, and are configured as higher aspect ratio cladding material portions. In various embodiments, the webs may be connected to the nodes, the nodes having a dimension, d₁, and configured as lower aspect ratio cladding material portions. In some embodiments, the D/Λ may be in a range from about 0.9 to about 0.995 and the PBGF is configured such that a relative wavelength transmission window Δλ/λc is larger than about 0.35.

### BRIEF DESCRIPTION OF THE DRAWINGS

FIGS. 1A and 1B are cross-sectional views that schematically illustrate examples of the photonic band gap fibers (PBGFs) having a hexagonal cladding fabricated from a plurality of hollow tubes with 7 and 19 tubes, respectively, removed to form a core.

FIGS. 2A-2F are cross-sectional views that schematically illustrate PBGF designs having cladding formed from hexagonally arranged microstructures that have wide transmission bandwidth and low transmission loss.

FIG. 3A is cross-sectional view that schematically illustrates an example of a hollow core (HC) photonic band gap fibers (PBGF) configured with a square lattice (SQL).

FIG. 3B is an exploded cross-sectional view of the HC SQL PBGF of FIG. 3A, and illustrates a unit cell of the SQL PBGF.

FIG. 4 is a block diagram illustrating fabrication steps utilized to make a SQL PBGF.

FIG. 5A schematically illustrates a stack formed as a square lattice and comprising capillaries, interstitial holes filled with silica rods, and a core.

FIG. 5B is a cross-sectional view that schematically illustrate of a preform cane representing a SQL PBGF at an intermediate stage of fabrication.

FIG. 5C is an exploded cross-sectional view of the cane of FIG. 5A.

FIG. 6 schematically illustrates a system for fabrication of a HC SQL PBGF.

FIG. 7A is cross-sectional view that schematically illustrates an example of a hollow core (HC) photonic band gap fiber (PBGF) configured with a square lattice (SQL).

FIG. 7B is an exploded cross-sectional view of the HC SQL PBGF of FIG. 7A.

FIGS. 8A and 8B schematically illustrate a construction of a SQL polarization maintaining (PM) fiber, and a corresponding preform.

FIG. 9A illustrates an image of a fabricated preform.

FIG. 9B illustrates an exploded region of the image of FIG. 9A.

FIG. 9C is a SEM image illustrating a cross-sectional view of a fabricated SQL PBGF drawn using the preform of FIG. 9A.

FIG. 9D is a SEM image illustrating an exploded view of the fiber illustrated in FIG. 9C.

FIG. 10 is a plot illustrating measurements of the transmission bandwidth of the fabricated fiber of FIGS. 9A-9D.

FIG. 11 is a block diagram schematically illustrating a single span telecommunication system incorporating a PBGF.

FIG. 12 is a block diagram schematically illustrating a multiple span telecommunication system incorporating PBGFs.

FIGS. 13A and 13B are block diagrams schematically illustrating fiber chirped pulse amplification systems incorporating PBGFs.

FIG. 14A is a block diagram schematically illustrating a gas detection system based on spectral transmission measurement using a PBGF.

FIGS. 14B and 14C are schematic drawings of a multiplexer and a demultiplexer, respectively, for combining and separating the gas and the light in the gas detection system of FIG. 14A.

FIG. 15A is a schematic illustration of a gas detection system based on backward Raman scattering in a PBGF.

FIGS. 15B and 15C are schematic drawings of a multiplexer and a demultiplexer, respectively, for combining and separating the gas and the light in the gas detection system of FIG. 15A.

FIG. 16A is a schematic illustration of a gas detection system based on forward Raman scattering in a PBGF.

FIG. 16B is a schematic drawing of a demultiplexer for separating the gas and the light in the gas detection system of FIG. 16A.

### DETAILED DESCRIPTION OF THE PREFERRED EMBODIMENT

Unless otherwise stated throughout this application transmission window refers to the width of a spectral transmission curve at approximately 10% of maximum intensity. In embodiments, where a spectral passband includes significant ripple or other fluctuations, the ripple intensity may be represented by an average or median value.

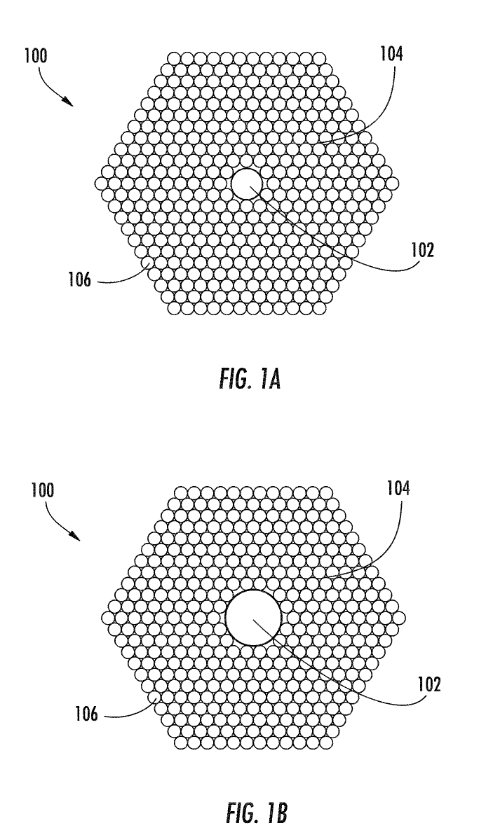

U.S. Pat. No. 7,209,619 (the '619 patent) which is incorporated herein by reference in its entirety for the subject matter specifically referred to herein and for all other subject matter it discloses, includes among the many structures described therein photonic bandgap fibers designed to provide a desired dispersion spectrum. Additionally, designs for achieving wide transmission bands and lower transmission loss are also discussed. For example, a photonic bandgap fiber (PBGF) 100 as shown in FIG. 1A was previously disclosed in the '619 patent. FIG. 1A and its related disclosure are incorporated herein by reference in its entirety. As disclosed in the '619 patent, the photonic band gap fiber (PBGF) 100 shown in FIG. 1A comprises a core 102 and a cladding 104, wherein the cladding comprising a plurality microstructures 106 arranged along hexagonally-shaped pathways about the core. Such a cladding 104 may, for example, be formed by stacking small thin wall tubes in a triangular pattern. As seen in FIG. 1A, this triangular pattern results in a hexagonal arrangement and may be referred to as hexagonal stacking as well. In some embodiments, the core 102 shown in FIG. 1A may be fabricated by excluding 7 tubes from the center of the hexagonally-shaped pathways. In FIG. 1B, the core 102 in the PBGF 100 is formed by leaving out 19 tubes resulting in a fiber with a larger core as compared to the fiber illustrated in FIG. 1B. FIG. 1B of the '619 patent and its related description is incorporated herein by reference in its entirety for the subject matter specifically referred to herein and for all other subject matter it discloses.

The fibers illustrated in FIG. 1A and FIG. 1B may be formed by drawing the tubes. Although the cladding 104 is created by stacking circular tubes, in various embodiments, the final cross-section of the fiber 100 may not contain circular holes because the interplay of surface tension and viscous flow during the drawing process may distort the circular holes. In various embodiments, the holes may be pressurized during drawing. The pressure may play a major part in determining the final hole geometry.

In various embodiments, the tubes may comprise hollow glass tubes, the glass portion comprising a relatively high index material in comparison to the hollow portion, which is empty and may be evacuated or filled with gas or air. After drawing, the glass portions fuse together forming a high index matrix having hollow regions therein. These hollow regions within the glass matrix form the microstructures 106 that provide the photonic band gap confinement of the cladding 104.

As discussed above, fibers 100 illustrated in FIG. 1A and FIG. 1B having a hexagonal arrangement are made by removing 7 or 19 tubes from the center of a hexagonal stack. Various embodiments of these fibers may exhibit a transmission window of less than 100 nm. Yet for many applications, a much wider transmission band can be useful. In various embodiments disclosed in the '619 patent, a wider transmission band or window can be achieved by reducing the thickness of the high index materials in the cladding. Additionally, transmission loss has a minimum at an optimized thickness of this high index material in the cladding. Higher leakage loss can result at very small thickness of the high index cladding material, and thus, the cladding no longer provides good confinement. A greater number of tubes or resulting microstructures can be removed from the center to provide for the desired core size. A preform comprising the plurality of tubes with many tubes in the center removed can be drawn down to provide a desired core size. The cladding dimension can be substantially reduced when drawn down to give a desired core size. Accordingly, in various embodiments of a hexagonal PBGF, the transmission band is large, while transmission loss may also be substantially reduced.

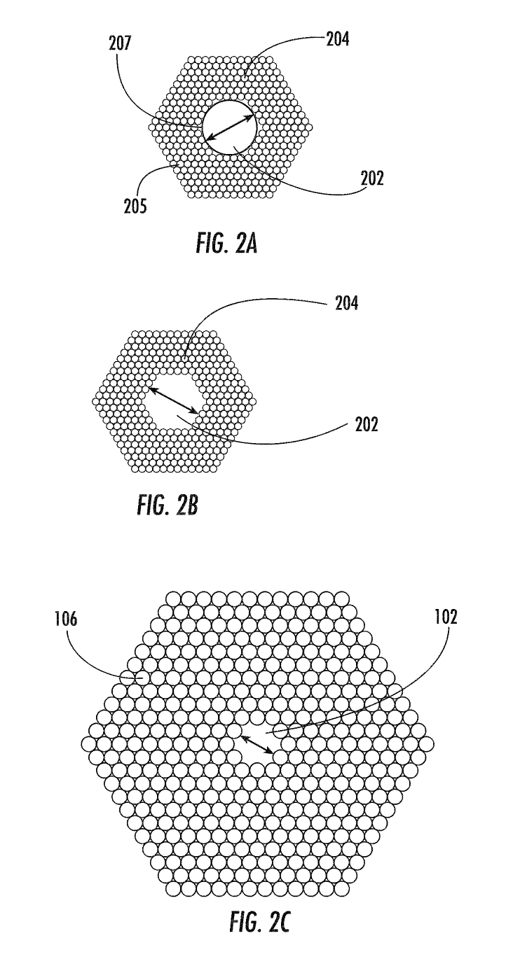

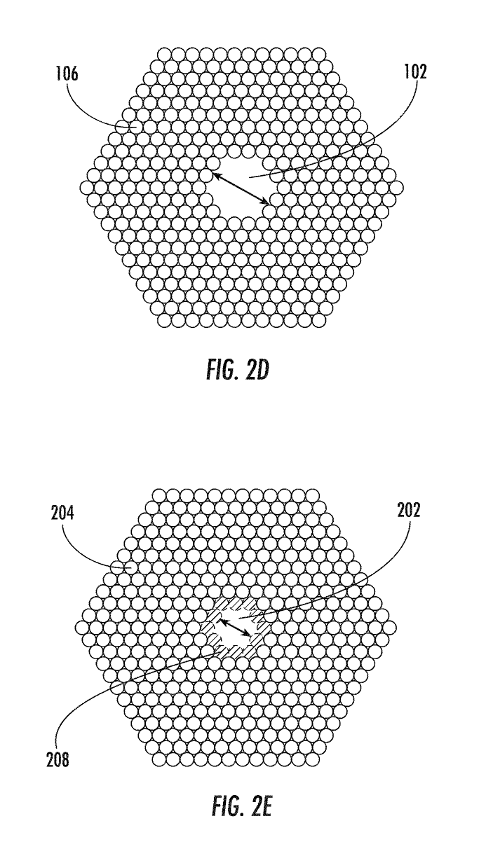

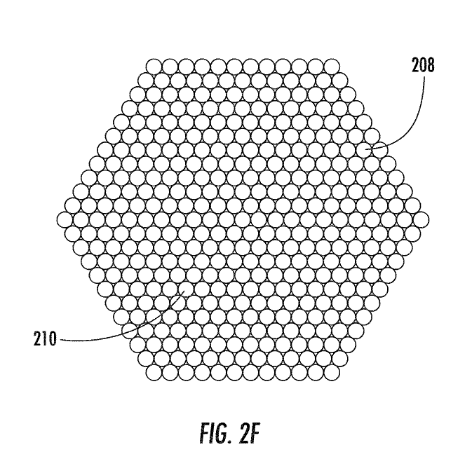

An illustration of a hexagonal stacked preform is shown in FIG. 2A, comprising a core 202, a cladding 204 formed by stacking tubes 205. A core tube 207 is used to form the core 202. In this embodiment, small dimension for the high index material is achieved by leaving out much more than 19 tubes when forming the core 202 using the triangularly stacked cladding. The preform is then drawn to yield a certain core size after drawing. The cladding dimension is much reduced compared to other designs with a similar core size.

Apart from confinement loss, an additional loss mechanism in PBGF is from the presence of surface modes around the core. Guided core modes can couple power into the surface modes. Part of this coupled power is subsequently lost. The presence of surface modes is a direct consequence of removing tubes in a regular matrix to form a core. Advantageously, however, the number of surface modes can be reduced by reducing or minimizing the width of the high index material around the core. In various preferred embodiments disclosed in the '619 patent, the width of the core/cladding boundary is much further reduced than that of the corresponding cladding. Much stronger coupling exists between the guided core modes and these surface modes than that of the guided core modes and the modes supported in the cladding. The width reduction of the core/cladding boundary is provided by the techniques described above for reducing the width of the high index material in the cladding structure.

Accordingly, as disclosed in the '619 patent, some loss in PBG fibers is due to the presence of surface modes around the core and cladding interface formed by the high index material closest to the core. This high index material may comprises a layer, which may be annular or ring-shaped as seen in the cross-section such as shown in FIG. 2A. This high index material forms a high index boundary around the hollow core 202 that has a relatively low index. The high index material layer may be formed at least in part by the core tube 207. The surface modes are supported by this high index boundary around the core. As described above, these surface modes can act as leakage channels for guided core modes. The core modes can couple power into these surface modes and the power is then lost through further coupling into cladding modes or radiation modes. One method of solving this problem is to reduce the width of the high index boundary around the core. Decreasing the width of the high index boundary may be accomplished by removing the core tube 207 in FIG. 2A. The improved design is schematically illustrated in FIG. 2B, where the core tube 207 is removed to reduce the thickness of the high index boundary around the core 202. The designs in FIGS. 1A and 1B can also benefit from removing the core tubes. These resultant designs are shown in FIGS. 2C and 2D. The core/cladding can also be selectively etched.

Additionally, in a construction of a hexagonal PBGF, a further step can be taken to eliminate surface modes. In this approach, a composite structure 208 is used in place of the tubes closest to the core 202 as is schematically illustrated in FIG. 2E. As shown, each of the tubes around the core are replaced with a composite tube. In this case, for example, twelve composite structures are used. An example of the composite tube or structure 208 is shown in FIG. 2F. This composite structure 208 is formed by stacking tubes 210 and then drawing the tubes down to an appropriate size to incorporate into the final preform. For example, large bundle of stacked tubes forming the composite structure are then drawn down to the same dimension as the tubes in the preform stack.

Repeated stacking and drawing can be used to further reduce the dimension of the high index material. More of the cladding tubes, especially the ones nearer to the core 202, can be replaced by the composite structure 208 to be benefited by the small dimension of the high index material. This approach thus can substantially reduce the glass dimension around the core. The general approach illustrated in FIGS. 2A-2F is not limited to triangularly stacked cladding and can be also be used in other methods of stacking. Other variations are also possible.

As disclosed in the '619 patent, circular ring-shaped regions offer some performance advantages in comparison to hexagonal ring-shaped regions illustrated in the FIGS. 2C and 2D. These advantages may include wider transmission bandwidth and lower transmission loss. Details are discussed below in connection with results of simulations of Bragg fibers. Such a Bragg fiber comprises the high and low index materials arranged in alternating concentric ring or ring-shaped regions about the core. A Bragg fiber is, however, difficult to implement when using air as the low refractive index material.

Recently a new class of hollow core fibers have been developed which relies not on photonic bandgap of the cladding for guidance, but also on a low density of modes of the cladding, see for example, Couny et al, “Large pitch kagome-structured hollow-core photonic crystal fiber” Opt. Lett., vol. 31, pp. 3574-3576, 2006. This new class of hollow core fibers can provide an extremely wide transmission band, but they exhibit high loss, typically, in the few dB/m. Thus, such HC fibers are not well suited for a wide range of applications where smooth spectral transmission and low loss are important.

Hollow Core (HC) photonic bandgap fibers (PBGF) with a square lattice have received some consideration, and some advantages have been recognized. A PBGF with a square lattice was studied by Chen et. al. in “Square-structured photonic bandgap fibers”, Optics Communications, vol. 235, pp. 63-67, 2004. Chen et. al. noted that photonic bandgaps can exist in HC PBGFs with square lattice. Buczyńsky et. al. fabricated a hollow core fiber with square lattice as reported in “Hollow-core photonic crystal fibers with square lattice”, Proc. of SPIE, vol. 5950, 595015, 2005. A recent theoretical study, disclosed a square lattice PBG fiber, see for example, Poletti et. al. “Hollow-core photonic bandgap fibers based on a square lattice cladding”, Opt. Lett., vol 32, pp. 2282-2284, 2007.

In their study, Polletti et. al. “demonstrated that the width of the PBG crossing the air line can be up to 20% wider than achievable in a triangular lattice for an optimal choice of hole shape and can reach up to 38% of the central wavelength for a realistic cladding structure.” Thus a large bandgap along air line of Δλₐ/λ_{c}=0.38 is possible, where Δλₐ is the bandwidth along the air line and λ_{c} is center wavelength of the bandgap. However, a typical transmission bandwidth is much narrower. In a further simulation with 8 layers of air holes and 9 missing holes for the core, the analysis indicated a reduced relative transmission bandwidth. Applicants estimate that Δλ/λ_{c}=29% was obtained where Δλ is the 10% transmission bandwidth, and a minimum transmission loss of approximately 60 dB/km at approximately 1.55 μm was achieved by Polleti et. al. Polleti et al. recognized “that the widest bandgap is achieved by hole shapes that generate thin struts between two adjacent holes while providing large rods of glass at the intersection of four holes.”

Various embodiments described herein comprise hollow core (HC) photonic bandgap fibers (PBGF) wherein a cladding is formed with a square lattice (SQL). In various embodiments, the SQL structure may have a core formed by excluding 4, 9, 16, or 25 tubes. Some aspects of hexagonal and/or Bragg fiber design and fabrication, as described in the '619 patent and above, are also applicable to SQL PBGFs. When compared to Bragg fibers, however, accurate simulation is particularly difficult, in part because of resolution limits and numerical round-off considerations.

Use of SQL designs and performance evaluations are not widespread. Recently, however, it was recognized that HC SQL PBGFs can have some advantages, particularly increased transmission bandwidth. As disclosed herein, in various embodiments, geometric properties of the cladding of a SQL cladding structure were used and with fabrication techniques discussed below, further extended the transmission window and decreased the loss of PBGFs relative to both hexagonal and prior SQL designs.

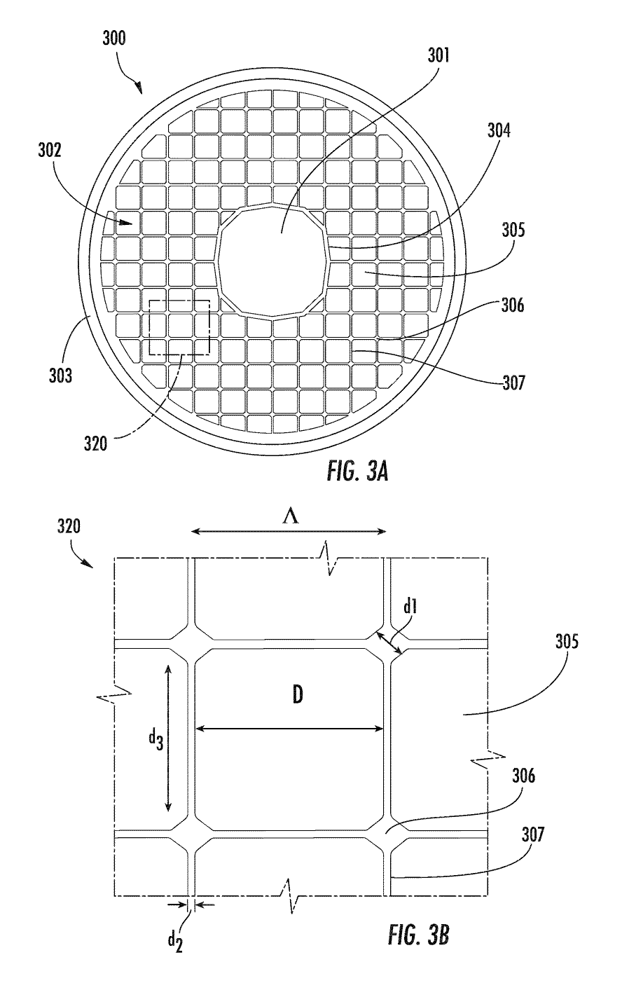

FIG. 3A schematically illustrates a cross section of a HC PBG fiber 300 with a square lattice. The fiber 300 has a core 301, a cladding area 302 with a square lattice comprising a high index glass, and an outer cladding area which may comprise a polymer coating 303. The SQL PBGF of FIG. 3A also includes core and cladding boundary 304, holes 305 at least partially surrounded by cladding material, nodes 306 and webs 307 of glass material connecting adjacent nodes. In various embodiments, the glass may comprise silica.

FIG. 3B is an exploded cross sectional schematic view of a portion of the fiber 320 of FIG. 3A that illustrates a region (e.g.: unit cell) of the square lattice. In this example the region is characterized with a pitch Λ that is a dimension of the lattice region, a hole dimension D, a node size d₁, a web length d₃ and a web width d₂. In this example web 307 comprises an elongated, high aspect ratio, cladding material portion. In some embodiments, the length to the width ratio of the webs may be approximately 5:1. In some embodiments, a length to the width ratio (d₃/d₂) of the webs may be approximately 10:1, 15:1, 20:1 or 25:1. The ratio D/Λ is affected by web width d₂, and approaches unity with an exceedingly thin web dimension. The ratio d₁/Λ is determined at least in part by the shape of hole 305, particularly near the intersection of regions. Various ratios affect the formation of photonic bandgaps in the cladding area 302.

In various embodiments of SQL PBGFs described herein, a wider transmission band or window can be achieved by greatly reducing the thickness of the high index webs 307 while maintaining relatively large high index nodes 306 in the cladding 302. Additionally, in various embodiments, transmission loss has a minimum at an optimized structure of this high index material in the cladding. Higher leakage loss can result at very small node size of the high index cladding material, and thus, the cladding no longer provides good confinement. In various preferred embodiments, the width of the core/cladding boundary is much further reduced than that of the corresponding node size in the cladding. Moreover, such a relative reduction of the core/cladding boundary may be beneficial in the construction of hexagonal PBGFs, or for other PBGF lattice configurations.

In various embodiments to increase transmission bandwidth and reduce transmission loss of a PBGF, the cladding lattice is formed so that nodes of appropriate dimensions can provide for significant large photonic bandgaps, while supporting webs are reduced to the extent feasible with fabrication technology, or sufficiently reduced so that they do not support any modes and/or affect modes supported by the nodes which would narrow the larger bandgap provided by the nodes. An effective way to increase photonic bandgap in the cladding is to reduce the width of high index webs of the cladding. The physical dimension of the optical material with the high refractive index is small enough so it supports few modes, with very little impact on the modes supported at the nodes, so that photonic bandgap can form over certain wavelength range.

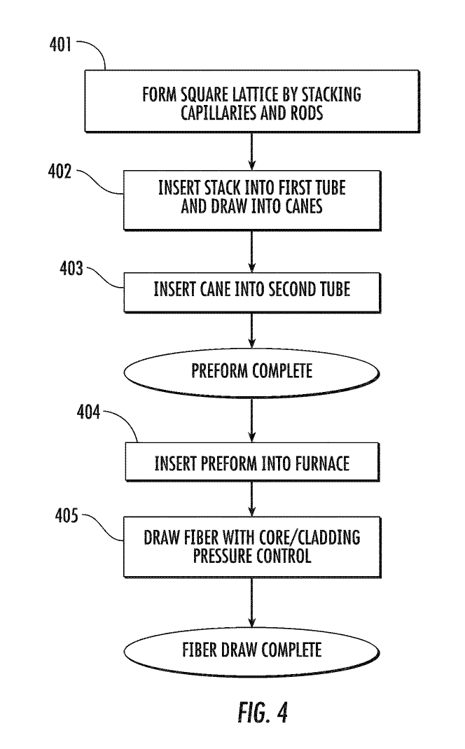

FIG. 4 is a schematic block diagram illustrating several fabrication steps used to form a HC SQL PBG fiber on a square lattice. A stack is first formed by stacking capillaries in a square lattice with interstitial spaces containing silica rods as illustrated in step 401. A core in the stack is formed by excluding a number of tubes. In various embodiments an optional larger core tube can also be used in place of the missing capillaries. The stack is then inserted into a first tube, and a cane is drawn of few millimeters in diameter as illustrated in step 402. The cane is subsequently inserted into a second tube and drawn into a fiber as shown in step 403 resulting in a completed preform. The completed perform may be inserted into a furnace as illustrated in step 404 and a fiber having core/cladding pressure control maybe drawn as shown in step 405. In various embodiments the drawn fiber may have an outer diameter in a range from about 50 μm to about 500 μm.

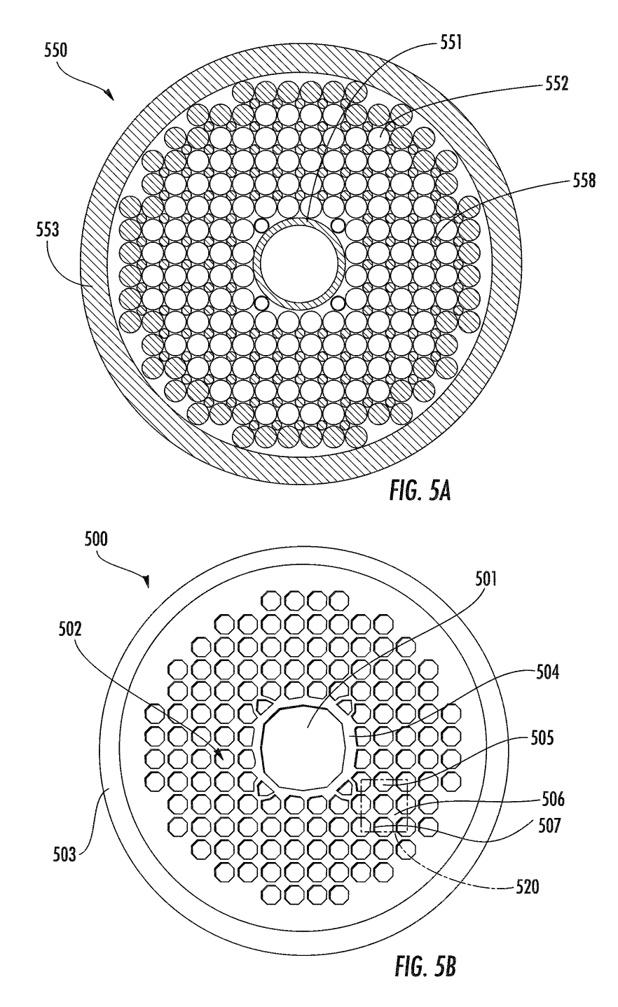

FIG. 5A schematically illustrates a stack 550 formed as a square lattice. The interstitial space between capillaries 552 includes silica rods 558. Core tube 551, adjacent spacers, and tube 553 enclose the square stack. In this embodiment, the cladding structure in cross-section comprises a two-dimensional periodic structure formed by a square stacked arrangement that forms non-hexagonal layers. The rods 558 eventually form relatively large nodes (e.g. nodes 306 in the SQL PBGF fiber 300), and the structure is beneficial in the formation of photonic bandgaps in the cladding.

FIG. 5B schematically illustrates a cross-sectional view showing a HC SQL PBG cane at an intermediate stage of fabrication, and corresponds to a cross section image of the preform cane. Cane 500 has a core 501, a cladding area 502 with a square lattice, and an outer cladding area 503. The cane 500 also includes an air core which is formed by excluding the pre-determined number of rods from the stack. Other features include core and cladding boundary 504, holes 505, nodes 506 and webs 507. FIG. 5C is an exploded cross sectional view of region 520 of FIG. 5B. FIG. 5C further illustrates a cladding unit cell of the cane square lattice with pitch Λ, hole size D, node size d₁ and web width d₂ (corresponding with the characterization of SQL PBGF 300 of FIG. 3).

Cane 500 can then be inserted into another tube which completes fabrication of the preform. By way of example, a tube with an outer diameter of 22.1 mm and inner diameter of 3.94 mm can be used. The preform can then be drawn into a fiber.

In some embodiments of a PBG SQL fiber having large transmission bandwidth, a cane 500 may be configured with cane parameters D/Λ=0.86, d₂/Λ=0.14, and d₁/Λ=0.52. In various embodiments, parameter ranges may include cane parameters D/Λ=0.5-0.95, d₂/Λ=0.05-0.5, and d₁/Λ=0.2-0.6.

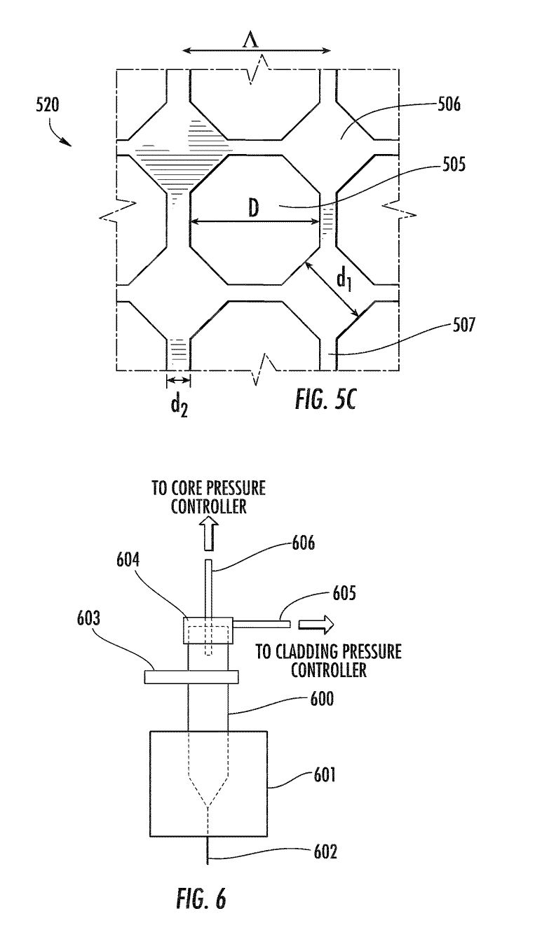

FIG. 6 schematically illustrates a system for fabricating a HC SQL PBGF with pressurized fiber core and cladding. In various embodiments, preform 600 can be inserted in furnace 601 where it is drawn into fiber. In some embodiments, the preform 600 can be held by a preform-holder 603. A pressure adaptor 604 is installed at the top of the preform 600 where core pressure is controlled through tube 606 and cladding hole pressure is controlled through tube 605. In various embodiments Argon or Nitrogen can be used in the pressurization process.

The cladding holes and core can be pressurized differently during the fiber draw process. In various embodiments cladding holes can be pressurized to higher pressure than the core pressure. For example, in some embodiments, cladding holes are pressurized to a pressure of 1.6 psi and the core is pressurized to a pressure of 0.9 psi. In various preferred embodiments, cladding holes can be pressurized to a pressure in the range of approximately 0.5-2.5 psi and the core is pressurized to a pressure in the range of approximately 0.2-2 psi. In various embodiments, drawing temperature can be about 1900° C. In various preferred embodiments a drawing temperature range of approximately 1850° C. to approximately 2050° C. can be utilized. In at least one embodiment, the preform is fed at a rate of approximately 3 mm/min and a fiber is drawn at a rate of approximately 100 m/min.

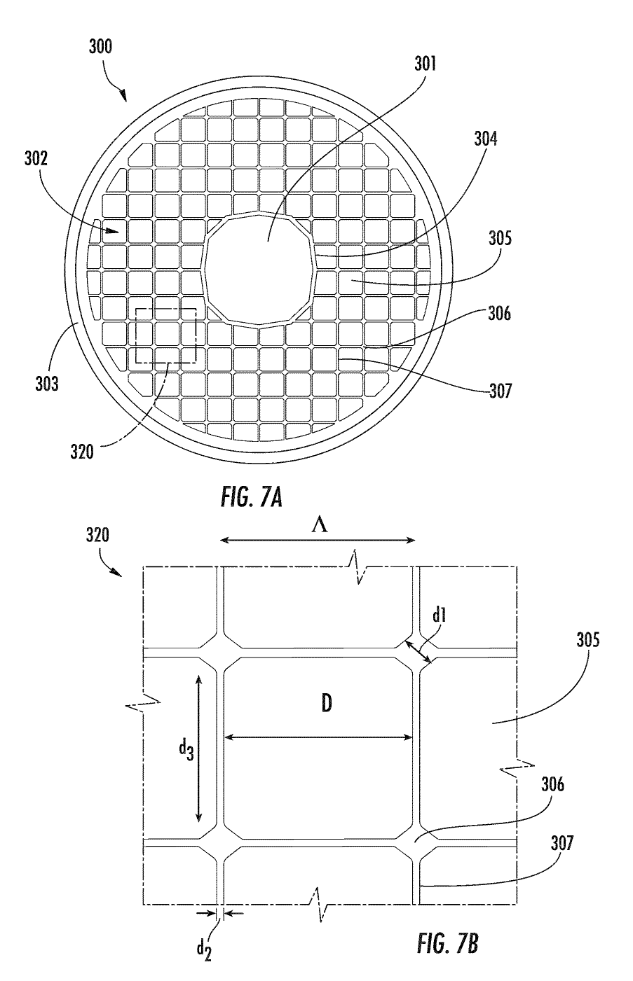

FIG. 7A schematically illustrates a cross-section of completed HC PBG fiber (and corresponds to the schematic of FIG. 3A). FIG. 7B also is an exploded cross sectional view further illustrates a cladding unit cell of the square lattice and also shows pitch Λ, hole size D, node size d₁ and web width d₂. When compared to the cane 500 of FIGS. 5A and 5B, the web width has been reduced substantially, and as will be shown by example below, at least as a result of the differential pressure applied to the core and cladding. In various embodiments, fibers 300 may have D/Λ=0.9-0.995, d₂/Λ=0.01-0.1, and d₁/Λ=0.1-0.5.

In various embodiments a polarization maintaining (PM) HC SQL PBGF fiber may also be fabricated with a modified preform. A perfect SQL PBGF has four-fold rotational symmetry and will not be birefringent, and therefore not polarization-maintaining.

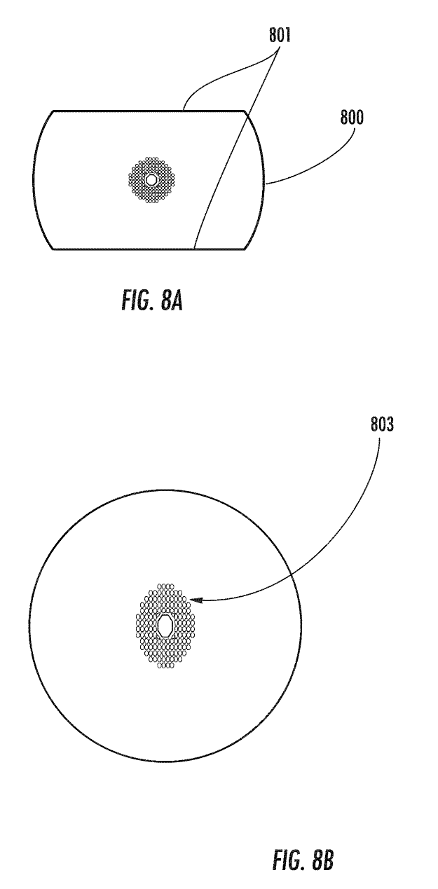

To make a PM HC SQL PBGF the symmetry can be reduced to two-fold rotational symmetry by a technique illustrated in FIG. 8A. Two flats 801 are ground on either sides of a portion of a circular preform 800. The orientation of the flats is not critical. However, a preferred orientation is along the orientation of webs and at 45 degree angle to the orientation of webs so that elongation of nodes can be increased. In some embodiments the flats may be oriented at other angles relative to the principal directions of the rectangular lattice. In various preferred embodiments, when the preform is drawn, the surface tension will force the fiber outer dimension towards a circular shape. As a result, deformation of both the cladding and core of the PBGF occurs.

As illustrated in FIG. 8B, the fiber shape 803 is then transformed into an approximate elliptical shape with a non-circular core. The shape of the holes may also be altered, but has little effect on PM and guidance. Thus, birefingence is introduced and the fiber becomes polarization maintaining. In the embodiment illustrated in FIGS. 8A and 8B 16 excluded holes were used to form the fiber core, Also, FIG. 8B illustrates a circular outer diameter of the fiber, however, in various embodiments an elliptical shaped outer diameter may also result.

Although illustrated with a HC SQL PBGF herein, such a PM fiber fabricating technique can be adapted for construction of other PM PBGFs, and implemented for hexagonal lattice designs, for example the designs disclosed in the '619 patent.

### Example I

### Fabricated HC PBGF with Rectangular Lattice

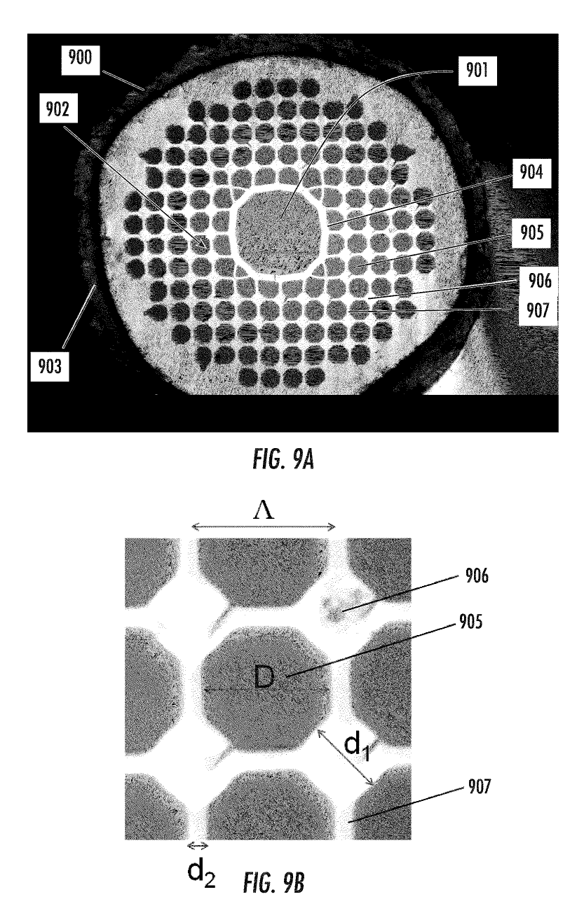

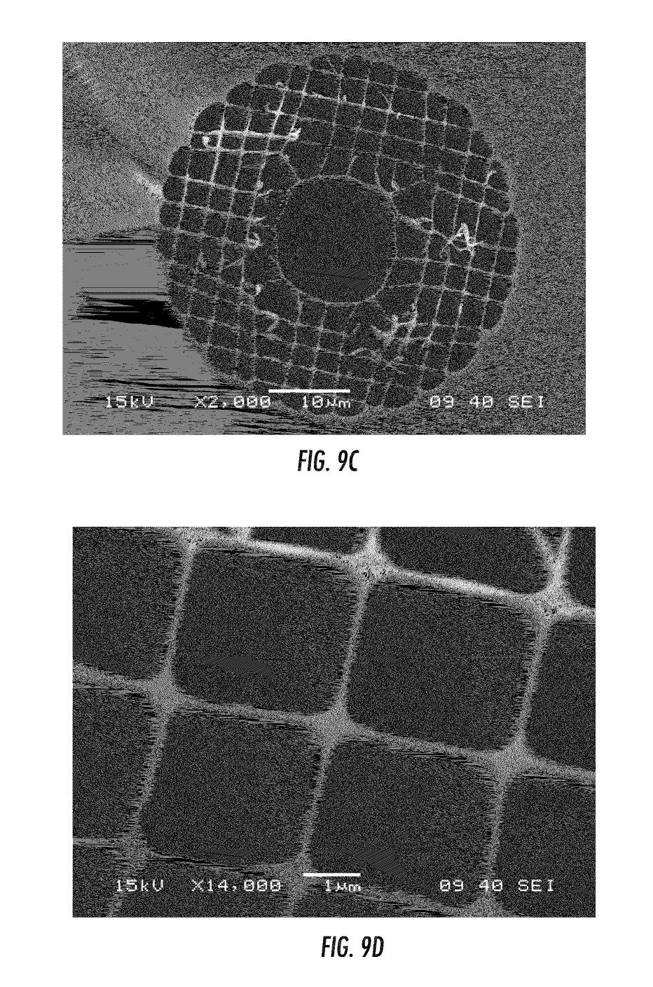

In the example described below, a HC SQL PBGF was fabricated with fiber outer diameter of 125 μm. FIG. 9A illustrates an image of a fabricated preform 900. Features 901-905 of fabricated preform 900 correspond with 501-507 of cane 500, and eventually with 301-307 of fiber 300. FIG. 9B illustrates an exploded region of a portion of the image of FIG. 9A and shows a unit cell of preform 900. FIG. 9C is a scanning electron microscope (SEM) image illustrating a cross-sectional view of a fabricated SQL PBGF drawn using the preform of FIG. 9A. The irregularities in FIG. 9C are believed to be by-products of the cleaving process for preparing fiber end for the photos, and not defects in the PBG fiber structure. Air-filling fraction is estimated to be larger than 83% in this example. FIG. 9D is a SEM image illustrating an exploded view of the fiber illustrated in FIG. 9C, and illustrates the cladding structure of the fabricated fiber. As illustrated in the example of FIG. 9D, web width d₂ may estimated to be about 100 nm or less, giving d₂/Λ<approximately 0.03 (implying D/Λ>approximately 0.97). Pressurization steps appear to significantly reduce the web width, as illustrated by FIGS. 9C and 9D. Another fiber (not shown) was also fabricated with an outer diameter of 118 μm, core diameter of 14.2 μm, pitch Λ of 2.2 μm, and node size d₁ of 0.55 μm, giving d₁/Λ=0.25.

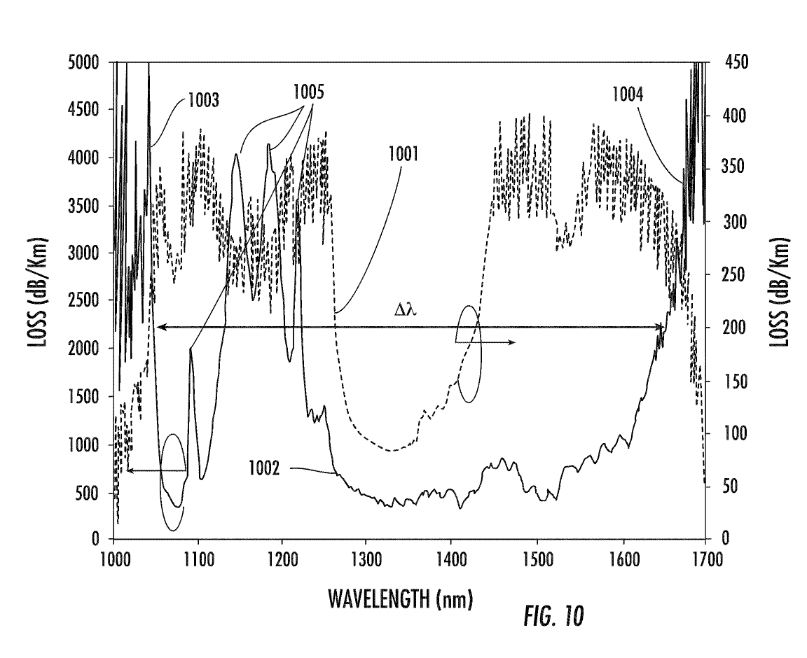

Transmission of the fabricated fiber was measured, and the results are illustrated in the plot of FIG. 10. FIG. 10 shows two curves 1001 and 1002 of the loss exhibited by the fibers over a range of wavelengths. The loss values for curve 1001 are plotted on the right hand side axis while the loss values for the curve 1002 are plotted on the left hand side axis. To obtain the first measurement shown in curve 1001 a fiber of length 100 m was used and then cut back to approximately 3.5 m. To obtain the second measurement plotted in curve 1002 a fiber of length 3.5 m was measured and then cut back to approximately 1.25 m.

The second measurement reveals the cladding bandgap characterized by the short wavelength band edge 1003 and long wavelength band edge 1004. The transmission window (bandwidth Δλ) is characterized by the wavelength span between the two steep rising band edges as shown. As a result of the thicker core and cladding boundary used in this example, a number of surface modes are supported. Guided core mode coupling to these surface modes leads to high loss at certain wavelengths at which phase matching of the two modes occurs. Some strong loss peaks due to surface mode coupling is indicated by the peaks 1005. These loss peaks significantly reduce transmission window for long fibers. Loss due to surface modes can be reduced by using a thinner core cladding boundary as disclosed in U.S. Pat. Nos. 7,209,619 and 7,418,836, which are incorporated herein by reference. The minimum loss measured in the first measurement as seen from FIG. 10 is approximately 85 dB/km.

In another example, a fiber with similar cross section, minimum loss of 70 dB/km was measured in a fiber with 5 rings/layers of air holes. The relative bandwidth Δλ/λ_{c} was estimated to be approximately 45%.

Without being limited to any particular theory or explanation, it is believed that the use of rods 558 in the interstitial holes in the stack 550, in combination with core/cladding pressurization, reduces or minimizes web thickness, while limiting changes in the node size. The transmission bandwidth is further extended, with low transmission loss. The narrow widths d₂ of the webs can be appreciated from examination of the SEM image of FIG. 9D, which shows a dimension well below 1 μm, and approaching about 100 nm. A node dimension d₁ is about 0.5 μm.

### Various Embodiments, Features, and Example Applications

Many variations and implementations of large bandwidth HC SQL PBGFs are possible. A wide variety of alternative configurations are also possible. For example, components (e.g., layers) may be added, removed, or rearranged. Similarly, processing and method steps may be added, removed, or reordered. For example, a lattice structure may be periodic or non-periodic. Hole sizes may be nearly uniform or may vary, for example with increasing hole size with radial distance. Hole shapes may vary, and may comprise a hole boundary having linear and curved portions. Holes may be regularly spaced, or irregularly spaced, for example randomly distributed. In various embodiments, the cladding glass may comprise silica. In various embodiments, a fiber diameter may be in a range from about 125 μm to about 400 μm and the core diameter may be in a range from about 10 μm to about 100 μm. In various embodiments, an air-filling fraction may be at least about 80% and up to about 95%. In various embodiments, a minimum transmission loss may be in a range from about 70 dB/km to about 0.1 dB/km. In various embodiments, a SQL PBGF may have a minimum loss in a range from about 70 dB/km to about 0.1 dB/km, with 2-10 layers of air holes, or with 2-5 layers of air holes. In various embodiments a web width may be less than about 200 nm, or in a range from about 50 nm to about 200 nm. An aspect ratio, corresponding to a length to width ratio d₃/d₂, of the webs may be in a range from about 5:1 up to about 40:1.

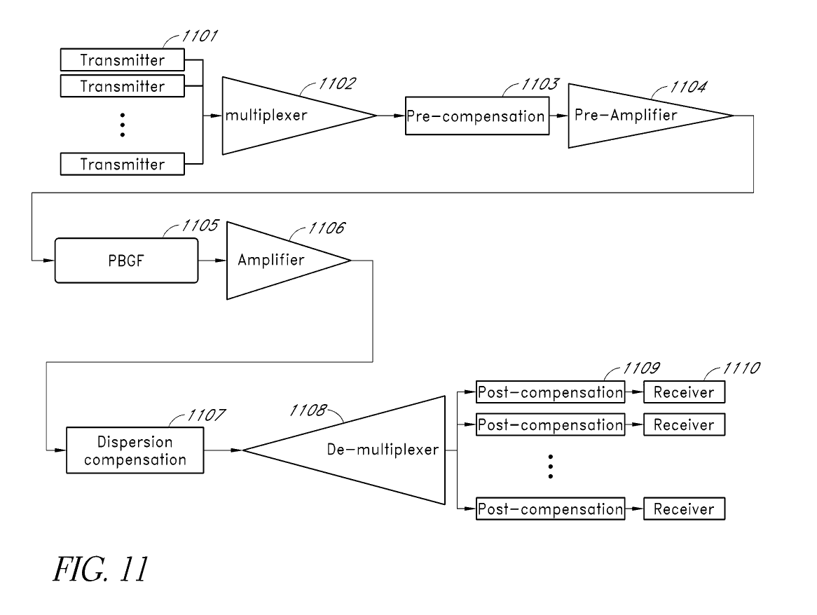

The photonic bandgap fibers described herein can be incorporated in numerous applications. For example, FIG. 11 is a block diagram schematically illustrating a single span telecommunication system incorporating a PBGF 1105 (e.g. a HC SQL PBGF, or other fibers described herein). Signals from transmitters 1101 are multiplexed by a multiplexer 1102 and are then pre-compensated by a dispersion pre-compensation unit 1103 and amplified by an amplifier 1104. A single span of PBGF 1105 is used for transmitting the signals over a distance from source to destination. The transmitted signals are then amplified at the destination by an amplifier 1106. A dispersion compensation unit 1107 is used before the de-multiplexer 1108. Each signal is finely compensated by post-compensation unit 1109 to take out any channel dependent transmission distortion before receipt by a plurality of receivers 1110.

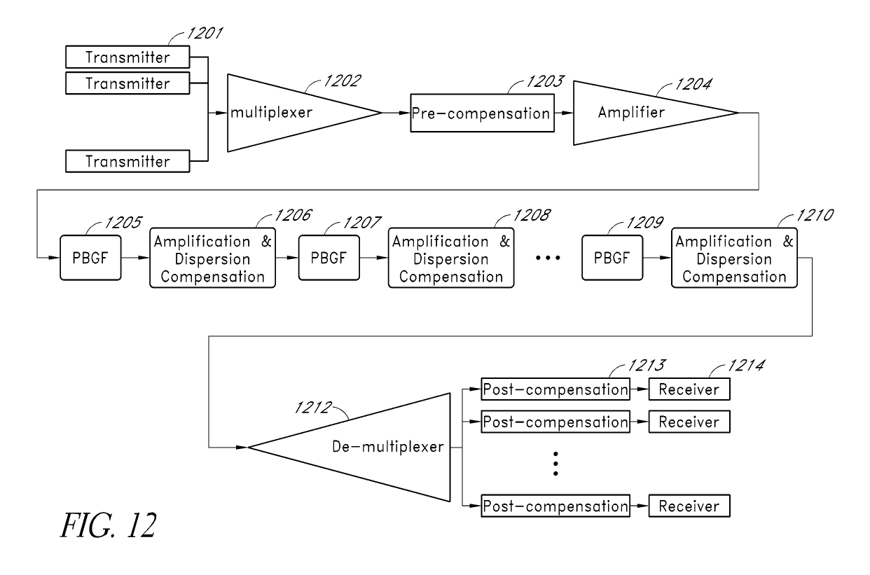

FIG. 12 illustrates a similar transmission system that also includes transmitters 1201, a multiplexer 1202, a pre-compensation unit 1203 and an amplifier 1204 on the source end and a demultiplexer 1212, a plurality of post-compensation units 1213 and receivers 1214 on the destination end. In the system shown in FIG. 12, however, multiple spans of PBGF 1205, 1207, 1209 are included. In various embodiments, the PBGFs 1205, 1207 and 1209 can comprise HC SQL PBGFs or other fibers described herein. Additional dispersion compensation units and amplifiers 1206, 1208, and 1210 in each span are also included. Optical connection is provided between the optical components as shown in FIGS. 11 and 12, although structures may be included between these optical components as well. A variety of these components may comprise optical fibers. FIGS. 11 and 12 only show the key components of a telecommunication system. Additional components can be added. Likewise, some components in FIGS. 11 and 12 can be omitted and/or locations changed in different embodiments. Other configurations and variations are also possible.

PBGFs can also be employed in systems for generating optical pulses such as ultrafast optical pulses. Additional details regarding ultrafast pulse systems is included in U.S. patent application Ser. No. 10/814,502 entitled “Pulsed Laser Sources” and U.S. patent application Ser. No. 10/814,319 entitled “High Power Short Pulse Fiber Laser”, which are incorporated herein by reference in their entirety.

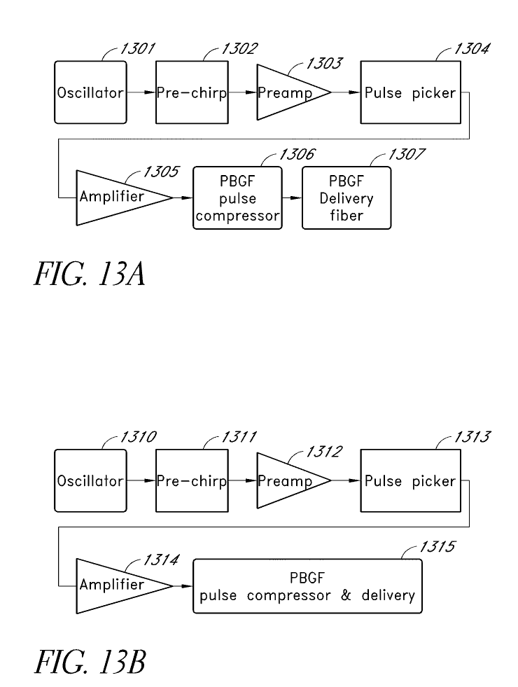

FIG. 13A, for example, illustrates a fiber chirped pulse amplification (FCPA) system incorporating a dispersion tailored PBGF 1306 (e.g. a HC SQL PBGF, or other fibers described herein). Pulses from oscillator 1301 are pre-chirped by using a pre-chirp unit 1302 and are then amplified by a pre-amplifier 1303. Pulse picker 1304 can be used to pick a subset of pulses, which are then amplified by main amplifier 1305. The PBGF 1306 is used to compress the amplified pulses, which are subsequently delivered by a low dispersion PBGF delivery fiber 1307. Optical connection is provided between the optical components as shown in FIG. 13A although structures may be included between these optical components as well. A variety of these components may comprise optical fiber or optical fiber devices. FIG. 13B, also shows a fiber pulse amplification system comprising an oscillator 1310, a pre-chirp unit 1311, a preamplifier 1312, a pulse picker 1313, and a main amplifier 1314. In FIG. 13B, however, the PBGF compressor and delivery fiber are combined into a single fiber 1315. In various embodiments, the combined fiber 1315 can comprise a HC SQL PBGF, or other fibers described herein. FIGS. 13A and 13B only show the key components of a pulse amplification system. Additional components can be added. Likewise, some components in FIGS. 13A and 13B can be omitted and/or locations changed in different embodiments. Other configurations and variations are also possible.

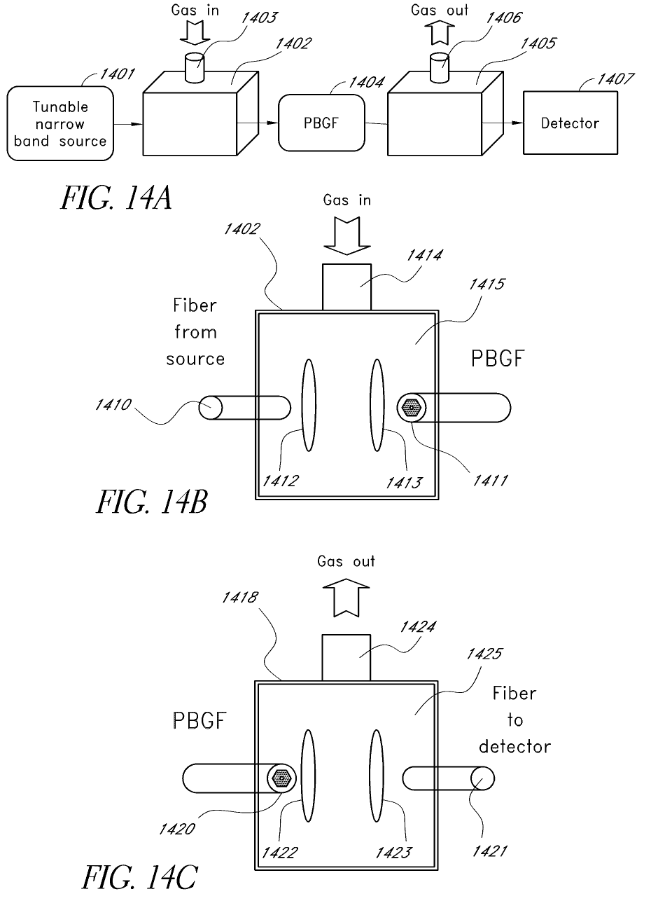

A PBGF (e.g. a HC SQL PBGF or other fibers described herein) with low loss and a wide transmission band can also be used for trace gas analysis with much improved sensitivity due to the long interaction length. FIG. 14A illustrates such a system that detects, identifies, quantifies, or otherwise performs measurements on gases based on spectral absorption. A tunable source 1401 is optically coupled to a PBGF 1404 through a multiplexer 1402, which allows gas to be injected into the core of the PBGF 1404. A gas filter 1403 may be employed to take out solid particles in the gas stream. At the output end, a de-multiplexer 1405 is used to separate gas and the optical beam. The optical beam is then directed to a detector 1407. Gas pumps can be connected to gas filter 1403 and/or gas outlet 1406 to speed up gas flow.

FIG. 14B illustrates a configuration of the multiplexer 1402 comprising a sealed chamber 1415. Source light propagated by a fiber 1410 is collimated by a collimating lens 1412 and focused by lens 1413 into an input end 1411 of the PBGF 1404. Gas is input through a gas input 1414 which may comprise a filter as described above. The de-multiplexer 1405 is illustrated in FIG. 14C. The de-multiplexer also comprises a chamber 1418, an output end 1420 of the PBG fiber 1404 as well as a collimating lens 1422 and a focusing lens 1423 which receives the light output from the output 1420 of the PBGF 1404 and couples the light into an output fiber 1421. The demultiplexer 1405 further comprises a gas output port 1424. In various embodiments, a broad band source and a monochromator can be used instead of the tunable light source 1401 in FIG. 14A.

In such a system gas is introduced into the multiplexer and enters into portions of the PBGF though holes or openings therein. In various preferred embodiments, the core is hollow and the gas enters the hollow core. The gas affects the propagation of the light, for example, by attenuating the light due to absorption at one or more wavelengths. The absorption spectrum of the gas can, therefore, be measured using the detector 1508 and monochrometer or tunable filter 1507. In certain embodiments such as shown in FIGS. 14A-14C the gas is flowed through the PBGF 1404. In such cases, the long length of the fiber 1404 may increase the interaction of the gas with the light and provide a higher signal. In other embodiments, other properties of the light may be measured.

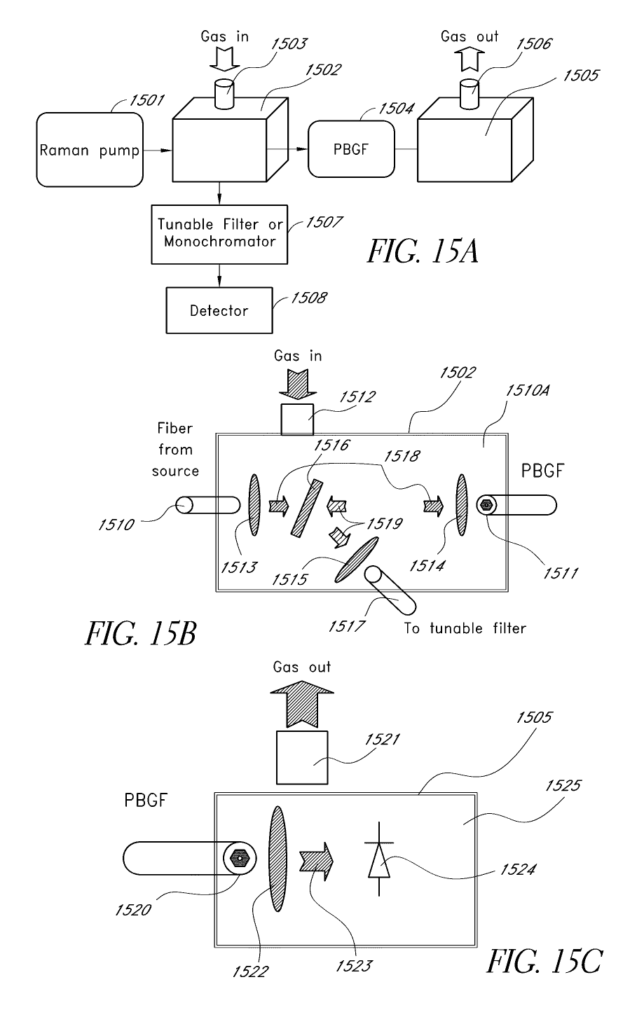

FIG. 15A, for example, illustrates a trace gas detection system based on detection of Raman scattered light. The gas is introduced into the fiber and causes Raman scattering which is measured. The gas may enter openings in the fiber and may, in certain preferred embodiments, flow through the hollow core of the PBGF. As described above, the long interaction length of the PBGF provides increased detection sensitivity. An additional advantage is that a large part of the Raman-scattered light is collected and can also propagate within the photonic bandgap fiber. This feature is especially true for PBGF with a wide transmission band, i.e. larger solid collection angle.

In the embodiment shown in FIG. 15A, a Raman pump 1501 is optically coupled through a multiplexer 1502 to a PBGF 1504. An output end of the PBGF 1504 is optically coupled to a de-multiplexer unit 1505. Gas enters through a filter 1503 that removes solid particles. Gas exits through the outlet 1506 on the de-multiplexer. Pumps can be used at the inlet 1503 and the outlet 1506 to speed up gas flow. Back-propagating scattered light by Raman scattering is directed towards a tunable filter or a monochromator 1507 and onto the detector 1508. The tunable filter or monochomator 1507 and detector 1508 can measure the wavelength spectrum of the scattered light.

The multiplexer 1502 comprising a sealed chamber 1510A is illustrated in FIG. 15B. Pump light is carried in by an optical fiber 1510 optically coupled to the pump source 1501 and is then collimated by a collimating lens 1513. The collimated pump beam 1518 is focused by a focusing lens 1514 into an input end 1511 of the PBGF 1504. A back-propagating scattered Raman signal 1519 is reflected by a filter 1516, which is designed to only reflect Raman signal but not the pump light. The Raman signal 1519 is focused by a focusing lens 1515 onto an output fiber 1517 optically connected to the tunable filter or monochromator. Gas enters in through an gas inlet port 1512 which may comprise a filter.

The de-multiplexer 1505 is illustrated in FIG. 15C. The de-multiplexer 1505 comprises a sealed chamber 1525 and a collection lens 1522 that collect pump light from an end 1520 of the PBGF 1504. The de-multiplexer further comprises a detector 1524 for monitoring the pump light that propagates through the PBGF 1504. The collection lens 1522 couple the pump light from the end 1520 of the PBGF 1504 and directs the pump light onto the detector 1524.

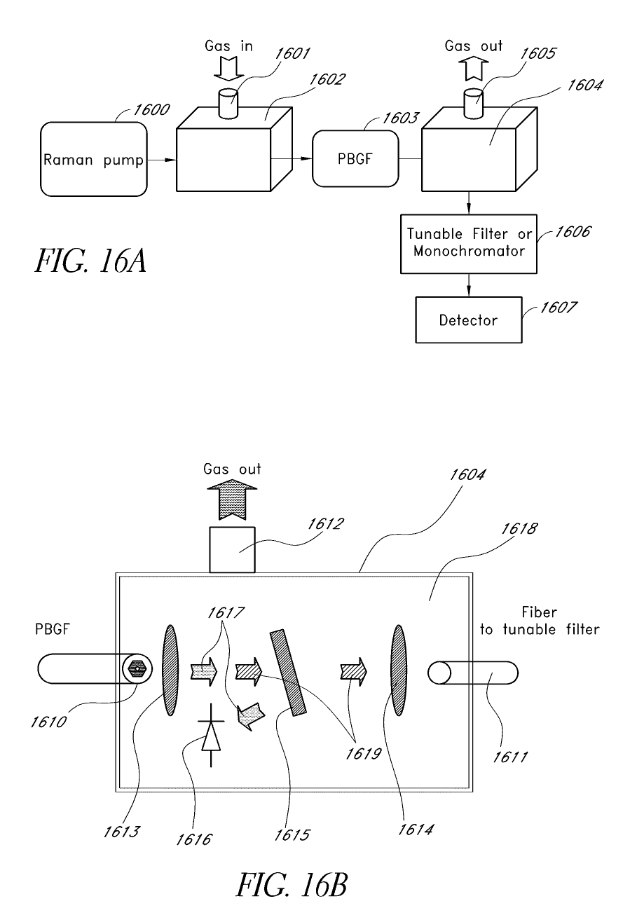

FIG. 16A shows a Raman detection system based on detection of a forward propagating Raman signal. In certain preferred embodiments, operation is in the stimulated Raman regime, where much stronger signal is expected due to amplification in the presence of high pump power. The configuration shown in FIG. 16A can also be used in a stimulated Raman mode to detect stimulate Raman emission.

The Raman detection system shown in FIG. 16A comprises a Raman pump 1600, a multiplexer 1602 having a gas input port 1601, a PBG fiber 1603, and a demultiplexer 1604 having a gas output port 1605. The system further includes a tunable filter or monochromator 1606 optically coupled to the demultiplexor 1604 so as to receive the Raman signal therefrom. A detector 1607 is also included to sense the Raman signal.

The de-multiplexer 1604 is illustrated in FIG. 16B. The demultiplexer 1604 comprises a sealed chamber 1618 that contains the gas. Pump and Raman signals are introduced into the chamber 1618 by an output end 1610 of the PBG fiber 1603. The pump and Raman signals are collimated by a collimating lens 1613. The Raman signal 1619 passes through filter 1615, which is designed to reflect the pump light. This Raman signal 1619 is focused by a lens 1614 onto the fiber 1611 that directs the light to the tunable filter or monochromator 1606. The pump light 1617 is reflected by the filter 1615 onto a detector 1616 for power monitoring. The multiplexer 1602 is similar to that shown in FIG. 14B.

Optical connection is provided between the optical components as shown in FIGS. 14A, 15A, and 16A although structures may be included between these optical components as well. A variety of these components may comprise optical fiber or optical fiber devices.

The systems and components shown in FIGS. 14A,-14C, 15A-15C, 16A, and 16B are examples only. One skilled in the art may devise alternative configurations and designs. For example, the filter 1516 shown in FIG. 15B can be designed to reflect the pump light and pass the signal. The fiber positions may be different in such an embodiment. Similarly, the filter 1615 in FIG. 16B can be designed to reflect the Raman signal. Fiber positions may likewise be different. The pump monitoring functions in FIGS. 15C and 16B can be eliminated. Fibers used to carry light to filters and detectors in FIGS. 15B, 15B, 15C, and 16B can also be eliminated by using bulk optics. Alternatively, optical fibers can be used to guide the light. In some embodiments, the PBGF ends can be sealed while gas can enter and exit the core of the PBGF through holes drilled on the side of the fiber. In fact, many holes can be drilled along the fiber to speed gas flow and make gas uniformly distributed along the PBGF. In certain embodiments, however, gas enters and/or exits the PBGF through one or both endfaces.

Other variations are also possible. Additional components can be added to the systems. Likewise, some components in FIGS. 14, 15, and 16 can be omitted and/or locations changed in different embodiments. Other configurations and variations are also possible. The components can also be designed differently. For example, other configurations and designs the multiplexers and demultiplexers may be used. In certain embodiments, one or both the multiplexer or demultiplexer may be excluded. Additionally, in any of the example applications described herein a single continuous PBGF or separate portions of PBGF may be used.

Other applications not discussed herein or in the '619 patent are possible as well. Moreover, polarization-maintaining (PM) fibers as illustrated herein are often beneficial, and may be required for applications where preservation of polarization is important.

Accordingly, although the inventions described herein have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the inventions. It should be understood that various features and aspects of the disclosed embodiments can be combined with, or substituted for, one another in order to form varying modes of the disclosed inventions. Thus, it is intended that the scope of the present inventions herein disclosed should not be limited by the particular disclosed embodiments described above.

What is claimed is:

1. A photonic bandgap fiber (PBGF) for propagating light having a wavelength, λ, said fiber comprising:
a core; and
a cladding disposed about said core,
wherein said cladding comprises a plurality of regions, at least one region having a dimension, Λ, and is configured such that the cladding at least partially surrounds a hole having a hole dimension, D,
wherein said plurality of regions are arranged as a rectangular lattice,
wherein said portions of said cladding form webs and nodes of said lattice such that at least a portion of said webs have a dimension, d₂, and are configured as higher aspect ratio cladding material portions,
wherein a portion of the webs are connected to said nodes, at least a portion of said nodes having a dimension, d₁, and configured as lower aspect ratio cladding material portions, and
wherein D/Λ is in a range from about 0.9 to about 0.995 and said PBGF is configured such that a relative wavelength transmission window Δλ/λc is larger than about 0.35.

2. The photonic bandgap fiber of claim 1, wherein the webs have a second dimension d₃, such that the ratio of d₃ to d₂ is at least approximately 5:1.

3. The photonic bandgap fiber of claim 2, wherein the ratio of d₃ to d₂ is at least approximately 10:1.

4. The photonic bandgap fiber of claim 2, wherein the ratio of d₃ to d₂ is at least approximately 25:1.

5. The photonic bandgap fiber (PBGF) according to claim 1, d₂/Λ is in a range from about 0.01 to about 0.1, and d₁/Λ in a range from about 0.1 to about 0.5,

6. The PBGF according to claim 1, wherein Δλ/λc is in the range from about 0.35 to about 0.65.

7. The PBGF according to claim 1, wherein said rectangular lattice comprises 2 to 5 layers of cladding regions.

8. The PBGF according to claim 1, wherein said fiber is drawn from a preform having webs and nodes having sizes larger than d₁ and d₂, and said PBGF is configured such that a relative reduction in the node size is substantially less than a relative reduction in the web size.

9. The PBGF according to claim 8, wherein said preform is configured with preform parameters D/Λ=0.5-0.95, d₂/Λ=0.05-0.5, and d₁/Λ=0.2-0.6.

10. The PBGF of claim 1, wherein an air filling fraction of the cladding region exceeds about 80%, and up to about 95%.

11. The PBGF according to claim 1, wherein a dimension of said core is in a range from about 10 μm to about 100 μm.

12. The PBGF according to claim 1, wherein said fiber is configured as a PM SQL PBGF.

13. The PBGF according to claim 1, wherein said holes contain air.

14. The PBGF according to claim 1, wherein at least a portion of said high index cladding glass comprises silica.

15. A method of fabricating a SQL PBGF of claim 1, comprising:
stacking capillaries and rods to form a rectangular lattice, said rods comprising an optical material;
constructing a preform;
drawing said preform into a fiber;
controlling core and cladding pressure during said drawing, said core and cladding pressurized with different pressures, said controlling narrowing a web dimension, d₂, and substantially limiting changes in node dimension, d₁, of said SQL PBGF such that D/Λ is in a range from about 0.9 to about 0.99.

16. The method of claim 15, wherein cladding holes are pressurized from about 0.5 to about 2.5 psi and said core is pressurized from about of 0.2 to about 2 psi, and said pressurization of cladding holes exceeds pressurization of said core.

17. The method of claim 15, wherein a web dimension, d₂, is less than about 0.25 μm.

18. A method of manufacturing a polarization maintaining PBGF, comprising:
forming a cane comprising a lattice of cladding regions having four-fold symmetry, a core, and a having substantially circular outer diameter, said canes comprising an optical material;
forming a circular preform using said cane;
modifying said circular preform to form a non-circular shape;
drawing said preform into a fiber; and
transforming said four-fold symmetry of said lattice into two-fold symmetry by deforming said core and said cladding during said drawing thereby introducing birefringence into said fiber.

19. The method of claim 18, wherein said non-circular shape comprises flat boundary portions disposed opposite each other, and at a non-zero angle relative to axes defining said lattice.

20. The method of claim 18, wherein said lattice comprises a rectangular lattice.

21. A system for telecommunications, gas measurement, delivery of high peak power pulses, or laser pulse shaping, comprising a PBGF according to claim 1.

22. A SQL PBGF having a cladding region comprising 2-10 layers of air-holes and configured to provide a relative wavelength transmission window Δλ/λc larger than about 0.35 and a minimum transmission loss in a range from about 70 dB/km to about 0.1 dB/km.

23. A photonic bandgap fiber (PBGF) for propagating light having a wavelength, λ, said fiber comprising:
a core; and
a cladding region disposed about said core,
wherein said cladding region comprises a plurality of features, said features having a periodicity, Λ, and is configured such that the cladding region at least partially surrounds a hole having a hole dimension, D,
wherein said plurality of features are arranged as a rectangular lattice,
wherein said cladding region comprises webs and nodes of said lattice such that said webs have a width, d₂, and are configured as higher aspect ratio cladding material portions,
wherein the webs are connected to said nodes, said nodes having a dimension, d₁, and configured as lower aspect ratio cladding material portions, and
wherein D/Λ is in a range from about 0.9 to about 0.995 and said PBGF is configured such that a relative wavelength transmission window Δλ/λc is larger than about 0.35.
